(19) United States
(12) Patent Application Publication
(10) Pub. No.: US 2026/0128770 A1
(43) Pub. Date: May 7, 2026

(54) RIS-ADDED MULTI-INPUT MULTI-OUTPUT SYSTEM AND METHOD FOR CHANNEL ESTIMATION AND BEAMFORMING

(71) Applicant: IUCF-HYU (INDUSTRY-UNIVERSITY COOPERATION FOUNDATION HANYANG UNIVERSITY), Seoul (KR)

(72) Inventors: Song Nam HONG, Yongin-si (KR); Jeong Jae LEE, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 19/374,528

(22) Filed: Oct. 30, 2025

(30) Foreign Application Priority Data
Nov. 5, 2024 (KR) 10-2024-0155630

(51) Int. Cl. H04B 7/06; H04B 7/04

(52) U.S. Cl. CPC H04B 7/0617; H04B 7/04013

(57) ABSTRACT

According to an embodiment of the disclosed invention, a beamforming method of a wireless communication system including a base station, a reconfigurable intelligent surface, and a plurality of user equipment comprises: acquiring channel information between the base station and the reconfigurable intelligent surface; determining a phase change value input to the reconfigurable intelligent surface; and estimating a dependent channel based on the channel information, the phase change value, and an Lth column vector of an effective channel collected from the user equipment.

### CROSS-REFERENCE TO RELATED APPLICATION

This application claims priority under 35 U.S.C § 119 to Korean Patent Application No. 10-2024-0155630 filed on Nov. 5, 2024, in the Korean Intellectual Property Office, the entire contents of which are hereby incorporated by reference.

### TECHNICAL FIELD

The disclosed embodiment relates to a RIS-added multi-input multi-output system including a reconfigurable intelligent surface (RIS), which is configured to estimate a dependent wireless channel based on a low rank and perform hybrid beamforming suitable therefor.

### BACKGROUND

Wireless communication systems are widely deployed to provide various telecommunication services such as telephony, video, data, messaging, broadcast, or other similar types of devices. Such wireless communication systems may employ multiple-access technologies capable of supporting communication with multiple users by sharing available system resources (for example, bandwidth, transmission power, or other resources).

Examples of multiple-access technologies may rely on any of code division, time division, frequency division, orthogonal frequency division, single-carrier frequency division, or time division synchronous code division. These and other multiple-access technologies have been adopted in various communication standards to provide a common protocol that enables different wireless devices to communicate at city, national, regional, and even global levels.

Although wireless communication systems have achieved technological advancements over the years, challenges still remain to be solved. For example, complex and dynamic environments still attenuate or block signals between wireless transmitters and wireless receivers. For this purpose, research on various channel estimation and reporting mechanisms is required.

Among them, hybrid beamforming technology, which is used to manage and optimize the use of finite wireless channel resources, has been studied; however, there has been a limitation in that it is practically impossible to obtain dependent wireless channel information suitable for 6G communication. Here, the channel to be estimated with the assistance of a reconfigurable intelligent surface (RIS) is referred to as a dependent channel, and a new multi-input multi-output channel different from a conventional multi-input multi-output channel has become necessary. Conventionally, by using a compressed sensing algorithm through the sparsity of the dependent channel, channel estimation was efficiently performed, and a technology for optimizing hybrid beamforming suitable therefor was proposed. However, as the size of wireless communication systems continues to increase and the conventional channel estimation methods fail to exhibit good performance in 6G communication, there has arisen a need for a new technology.

Meanwhile, in order to secure a higher data transmission rate than that of 5G communication, 6G communication needs to increase frequency and bandwidth. Since radio waves in a high-frequency band are highly directional by nature, when there is a blockage in between, there has been a problem in that the radio waves are not well transmitted to a receiving end.

### SUMMARY

According to an embodiment of the disclosed invention, the present disclosure relates to a multi-input multi-output system and a method for channel estimation and beamforming, which estimate a newly defined dependent channel in addition to a conventional channel estimation method and perform hybrid beamforming optimization through the estimation.

A multi-input multi-output system and a method for channel estimation and beamforming according to an embodiment of the disclosed invention estimate a newly defined dependent channel in addition to a conventional channel estimation method and perform hybrid beamforming optimization through the estimation.

Through this, the multi-input multi-output system and the method for channel estimation and beamforming according to an embodiment of the disclosed invention simplify existing hybrid beamforming technology and enable a more practical system configuration at the same time.

### BRIEF DESCRIPTION OF THE DRAWINGS

FIG. 1 is a diagram for explaining an example of a wireless communication system according to an embodiment of the disclosed invention.

FIG. 2 is a block diagram of a base station and a user equipment according to an embodiment of the disclosed invention.

FIG. 3 is a flowchart for explaining a disclosed beamforming method.

FIG. 4 is a diagram for explaining an embodiment in which the disclosed wireless communication system reduces training overhead and computational complexity.

### DETAILED DESCRIPTION OF THE PREFERRED EMBODIMENTS

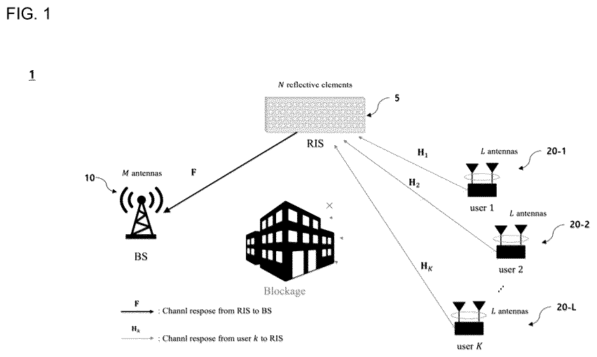

FIG. 1 is a diagram for explaining an example of a wireless communication system according to an embodiment of the disclosed invention.

Referring to FIG. 1, a wireless communication system 1 according to the disclosed invention may include a base station (BS) 10, a user equipment (UE) 20, and a reconfigurable intelligent surface (RIS) 5. In FIG. 1, a single base station 10 is illustrated; however, a plurality of user equipment 20-1, 20-2, . . . 20-L may perform wireless communication with a plurality of base stations 10.

The base station 10 may provide an access point for the user equipment 20 and may also perform various functions. Specifically, the base station 10 may perform transmission of user data, wireless channel encryption and decryption, integrity protection, header compression, mobility control functions (for example, handover and dual connectivity), inter-cell interference coordination, connection establishment and release, load balancing, distribution for non-access stratum (NAS) messages, NAS node selection, synchronization, radio access network (RAN) sharing, multimedia broadcast multicast service (MBMS), subscriber and equipment tracking, RAN information management (RIM), paging, positioning, and delivery of warning messages.

The base station 10 may include a gNB, NodeB, eNB, ng-eNB, access point, base transceiver station, radio base station, radio transceiver, or transceiver function, or a transmission and reception point in various contexts.

The base station 10 communicates wirelessly with the user equipment 20 through a communication link. The base station 10 may provide communication coverage for an individual geographic coverage area. However, a small cell (for example, a low-power base station) may have a coverage area that overlaps with a coverage area of one or more macrocells (for example, high-power base stations).

A communication channel F, H between the base station 10 and the user equipment 20 may include uplink (or reverse link) transmission from the user equipment 20 to the base station 10 and downlink (forward link) transmission from the base station 10 to the user equipment 20. The communication channel F, H uses a multiple input and multiple output (MIMO) antenna technology including spatial multiplexing, beamforming, and transmission diversity.

The user equipment 20 may include, for example, various configurations capable of communicating with the base station 10 through an antenna, such as a cellular phone, a smartphone, a session initiation protocol (SIP) phone, a laptop, a personal digital assistant (PDA), a satellite radio device, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, or a sensor/actuator, and the like. The user equipment 20 may include Internet of Things (IoT) devices, such as parking meters, gas pumps, toasters, heart monitors, and the like, as well as vehicles, always-on (AON) devices, or edge processing devices. The user equipment 20 may also be referred to as a station, mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, or client.

The base station 10 may perform beamforming with the user equipment 20 to improve path loss and range of wireless communication signals. For example, the base station 10 and the user equipment 20 may each include a plurality of antennas such as antenna elements, antenna panels, and/or antenna arrays to facilitate beamforming.

The base station 10 may transmit a beamformed signal to the user equipment 20, and the user equipment 20 may receive the beamformed signal from the base station 10. The user equipment 20 may also transmit a beamformed signal to the base station 10, and the base station 10 may receive the beamformed signal from the user equipment 20.

Meanwhile, as illustrated in FIG. 1, a blockage may exist between the base station 10 and the user equipment 20. When a line-of-sight (LOS) path x of a beamformed signal is interrupted by the blockage, or when channel capacity or channel quality in the line-of-sight path is relatively low, the base station 10 and the user equipment 20 may perform communication through a reconfigurable intelligent surface (RIS) 5.

The reconfigurable intelligent surface 5 operates as a reflector for wireless communications. The reconfigurable intelligent surface 5 allows a signal from the base station 10 to be re-radiated from the reconfigurable intelligent surface 5 to reach the user equipment 20, or allows a signal from the user equipment 20 to travel toward the base station 10. For this purpose, the reconfigurable intelligent surface 5 may use a codebook for precoding one or more elements (for example, antenna elements or metasurface elements).

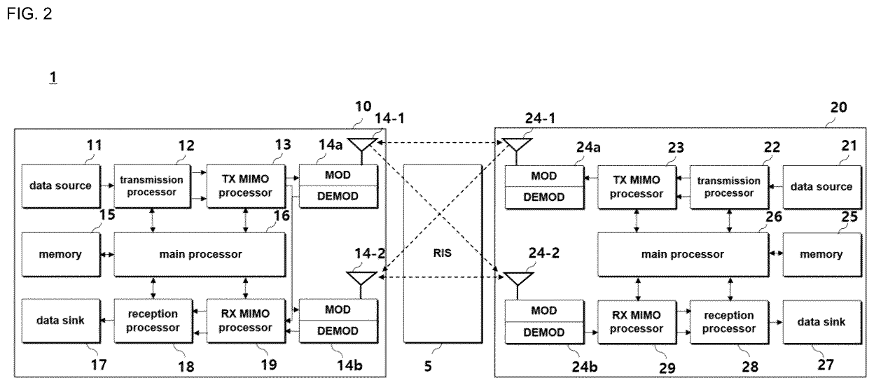

FIG. 2 is a block diagram of a base station and a user equipment according to an embodiment of the disclosed invention.

Referring to FIG. 2, the base station 10 may include a plurality of processors 12, 13, 18, and 19, a plurality of antennas 14-1 and 14-2, transceivers 14a and 14b including modulators and demodulators, a data source 11 enabling wireless transmission of data, a data sink 17 enabling wireless reception of data, and a memory 15 storing algorithms and data required for signal transmission.

The base station 10 includes a main processor 16 that controls the aforementioned configuration and enables wireless communication. The main processor 16 estimates a dependent channel and performs beamforming by controlling a transmission processor 12 and a reception processor 18 through the estimation. Here, the dependent channel refers to a channel to be estimated by the base station 10 with the assistance of the reconfigurable intelligent surface 5 and is different from a conventional MIMO input/output channel. Since the conventional dependent channel had sparsity, a compressed sensing algorithm could be used. However, as the size of the wireless communication system 1 and the strength of the signal gradually increase, it has become difficult to apply the conventional channel estimation method.

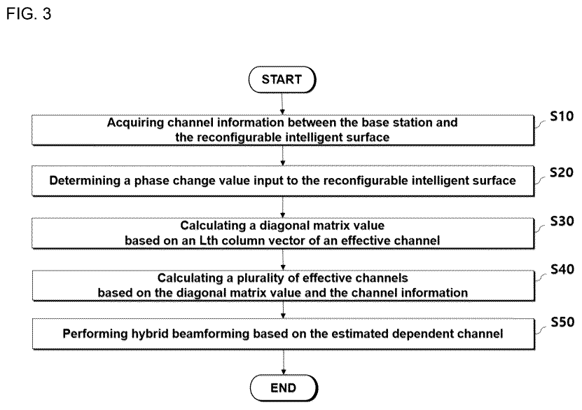

The disclosed main processor 16 acquires channel information F between the base station 10 and the reconfigurable intelligent surface 5, determines a phase change value v input to the reconfigurable intelligent surface 5 (see FIG. 3), and estimates a dependent channel based on the channel information F, the phase change value v, and an Lth column vector of an effective channel collected from the user equipment. The specific operation in which the main processor 16 estimates the dependent channel and performs beamforming will be described later with reference to other drawings.

The user equipment 20 may also include a plurality of processors 22, 23, 28, and 29, a plurality of antennas 24-1 and 24-2, transceivers 24a and 24b including modulators and demodulators, a data source 21 enabling wireless transmission of data, a data sink 27 enabling wireless reception of data, and a memory 25 storing algorithms and data required for signal transmission.

The user equipment 20 includes a main processor 26 that controls the above configuration and enables wireless communication. The main processor 26 of the user equipment 20 also estimates a dependent channel and performs beamforming by controlling a transmission processor 12 and a reception processor 18 through the estimation. The dependent channel herein refers to a channel to be estimated by the user equipment 20 with the assistance of the reconfigurable intelligent surface 5.

The reconfigurable intelligent surface 5 may be arranged to reflect electromagnetic waves in specified directions. The reconfigurable intelligent surface 5 may be regarded as a surface including densely packed, very small surface elements (for example, reflecting elements) Each surface element has a reflection coefficient, and a phase-shift value between incident and reflected rays to or from the surface element may be obtained.

By appropriately setting surface phases (for example, phases of reflection coefficients of predetermined surface elements), a downlink beam from the base station 10 may be reflected from the reconfigurable intelligent surface 5 toward the user equipment 20 in an uplink, or vice versa.

The reconfigurable intelligent surface 5 provides directional control of reflected waves or beams and may introduce lower losses due to reflection than other reflectors (for example, blockage). The reconfigurable intelligent surface 5 may operate with substantially no power consumption when it passively operates to reflect or refract beams from a transmitter toward a receiver.

A reflection or refraction direction of the reconfigurable intelligent surface 5 may be controlled by a separate controller such as the base station 10 or a network controller (not shown). The reconfigurable intelligent surface 5 may also be implemented in sidelink communications, for example, vehicle-to-vehicle (V2V) and/or device-to-device (D2D) communications.

The reconfigurable intelligent surface 5 is configured as a passive element and, unlike the base station 10 and the user equipment 20, does not perform active data processing. Therefore, in conventional general beamforming, it is impossible to perform beamforming optimization through the process of respectively acquiring channel information F between the base station 10 and the reconfigurable intelligent surface 5, a phase change value v of the reconfigurable intelligent surface 5, and channel information Hₖ between the user equipment 20 and the reconfigurable intelligent surface 5. Accordingly, the disclosed wireless communication system 1 estimates a dependent channel through a new definition as shown in [Equation 1].

$$F diag ( v ) {H}_{k} = {H}_{[ eff , k ]} ( I ⊗ v ) \qquad [ Equation 1 ]$$

Here, diag(v) denotes a diagonal vector of the phase change value v. A detailed description of how the wireless communication system 1 estimates the dependent channel through [Equation 1] will be described later with reference to other drawings.

Meanwhile, the base station 10 and the user equipment 20 are not necessarily limited to only the configurations mentioned in FIG. 2, and the disclosed embodiment may further include various modifications and combinations of each configuration.

FIG. 3 is a flowchart for explaining the disclosed beamforming method.

The wireless communication system 1 acquires channel information between the base station 10 and the reconfigurable intelligent surface 5 (S10) and determines a phase change value input to the reconfigurable intelligent surface 5 (S20).

As described above with reference to FIG. 2, it is practically impossible to estimate the dependent channel through the left term of [Equation 1] (F×diag(v)×Hₖ). Therefore, the disclosed beamforming method estimates the dependent channel through the right term of [Equation 1].

In [Equation 1], H_{[eff, k]} denotes an effective channel collected from the user equipment 20, I denotes an identity matrix having diagonal elements of 1, and ⊗ denotes a Kronecker product.

The wireless communication system 1 defines the effective channel H_{[eff, k]} as shown in [Equation 2].

$${H}_{[ eff , k ]} = [ {H}_{[ eff , k , 1 ]} , … , {H}_{[ eff , k , L ]} ] ∈ {C}^{M \times NL} \qquad [ Equation 2 ]$$

Here, k is the total number of user equipment 20 that transmits a signal for the channel to be estimated, L is the number of antennas included in each user equipment 20. N is the number of elements of the reconfigurable intelligent surface 5 as described with reference to FIG. 1, and M is the number of antennas of the base station 10.

The wireless communication system 1 calculates a diagonal matrix value based on an Lth column vector of the effective channel to derive the effective channel defined as shown in [Equation 2] (S30).

Specifically, the wireless communication system 1 calculates each matrix value of the effective channel through [Equation 3].

$${H}_{[ eff , k , l ]} = F diag ( {H}_{k} ( : l ) ) ∈ {C}^{M \times NL} \qquad [ Equation 3 ]$$

Here, diag(Hₖ(:l)) denotes a diagonal matrix value of an Lth column vector of the effective channel. The specific method by which the wireless communication system 1 estimates [Equation 3] through CLRA-JO is specifically disclosed in the material submitted as an exception to prior art, entitled “Near-Field Channel Estimation for XL-RIS Assisted Multi-User XL-MIMO Systems: Hybrid Beamforming Architectures.”

The wireless communication system 1 calculates a plurality of effective channels based on a diagonal matrix value and channel information (S40) and performs hybrid beamforming based on the estimated dependent channel (S50).

Specifically, the plurality of effective channels H are channels through which a plurality of user equipment 20 respectively communicate with the base station 10, and the base station 10 estimates the channels through [Equation 3] based on signals received from the plurality of user equipment 20.

The wireless communication system 1 performs hybrid beamforming based on the estimated dependent channel (S50).

The beamforming method performed by the wireless communication system 1 uses a general beamforming method. However, when the dependent channel is estimated through [Equations 1 to 3], the wireless communication system 1 can design the phase change v of the reconfigurable intelligent surface 5, and the hybrid beamforming method performed by the disclosed wireless communication system 1 can calculate an optimal value based on the estimated dependent channel.

Proof that the hybrid beamforming method calculates an optimal value is specifically disclosed in the material submitted as an exception to prior art, entitled “Asymptotically Near-Optimal Hybrid Beamforming for mmWave IRS-Aided MIMO Systems.”

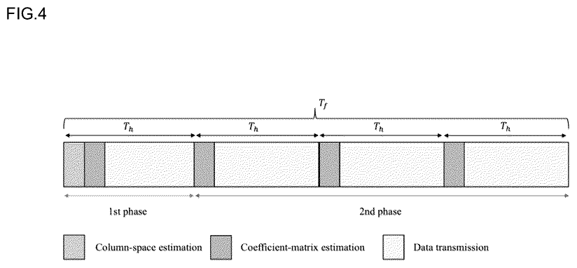

FIG. 4 is a diagram for explaining an embodiment in which the disclosed wireless communication system reduces training overhead and computational complexity.

Referring to FIG. 4, when the wireless communication system 1 estimates channel information F between the base station 10 and the reconfigurable intelligent surface 5 only once, the system can subsequently reduce the calculation complexity of the dependent channel by using only a coefficient matrix between the user equipment 10 and antennas.

Specifically, the wireless communication system 1 can decompose a matrix value H_{[eff, k, l]} of an effective channel through [Equation 4].

$${H}_{[ eff , k , l ]} = {S}_{col} {T}_{[ k , l ]} , k ∈ [ K ] , l ∈ [ L ] \qquad [ Equation 4 ]$$

Here, T_{[k, l]} is a coefficient matrix between the user equipment 20 and antennas, and S_{col} is a column space, that is, a basis vector, of channel information F. That is, the matrix value H_{[eff, k, l]} of the effective channel can be decomposed, in linear algebra terms, into T_{[k, l]} and S_{col}.

The wireless communication system 1 may use a CLRA-JO algorithm to estimate T_{[k, l]} and S_{col}, and as illustrated in FIG. 4, after estimating the column space (S_{col}) of the channel information F only once, the system estimates the dependent channel by receiving only the coefficient matrix (T_{[k, l]}) between the user equipment 10 and antennas.

### DESCRIPTION OF REFERENCE NUMERALS AND SYMBOLS

1: wireless communication system
5: reconfigurable intelligent surface
10: base station
20: user equipment

What is claimed is:

1. A beamforming method of a wireless communication system including a base station, a reconfigurable intelligent surface, and a plurality of user equipment, comprising:
acquiring channel information between the base station and the reconfigurable intelligent surface;
determining a phase change value input to the reconfigurable intelligent surface; and
estimating a dependent channel based on the channel information, the phase change value, and an Lth column vector of an effective channel collected from the user equipment.

2. The beamforming method according to claim 1, further comprising:
performing a Kronecker product based on a preset constant value and the phase change value.

3. The beamforming method according to claim 2,
wherein estimating the dependent channel comprises:
calculating a diagonal matrix value based on the Lth column vector of the effective channel; and
calculating effective channels of the plurality of user equipment based on the diagonal matrix value and the channel information.

4. The beamforming method according to claim 3, further comprising:
performing hybrid beamforming based on the estimated dependent channel.

5. A wireless communication system comprising:
a reconfigurable intelligent surface;
a base station configured to transmit and receive signals with the reconfigurable intelligent surface; and
a plurality of user equipment configured to transmit and receive signals with the reconfigurable intelligent surface,
wherein the base station:
acquires channel information between the base station and the reconfigurable intelligent surface,
determines a phase change value input to the reconfigurable intelligent surface, and
estimates a dependent channel based on first channel information, the phase change value, and an Lth column vector of an effective channel collected from the user equipment.

6. The wireless communication system according to claim 5,
wherein the base station performs a Kronecker product based on a preset constant value and the phase change value.

7. The wireless communication system according to claim 6,
wherein the base station:
calculates a diagonal matrix value based on the Lth column vector of the effective channel, and
calculates effective channels of the plurality of user equipment based on the diagonal matrix value and the channel information.

8. The wireless communication system according to claim 7,
wherein the base station performs hybrid beamforming based on the estimated dependent channel.
